(19) United States
(12) Patent Application Publication
(10) Pub. No.: US 2011/0137860 A1
(43) Pub. Date: Jun. 9, 2011

(54) Method for providing managing function of storage service

(75) Inventors: Hun Shin, Daegu (KR); Juncheol Hwang, Anyang-si (KR); Kwang Young Park, Seoul (KR)

(73) Assignee: KOREA I.O. TECH, Seoul (KR)

(21) Appl. No.: 12/659,387

(22) Filed: Mar. 8, 2010

(30) Foreign Application Priority Data
Dec. 3, 2009 (KR) 10-2009-0119023

(51) Int. Cl. G06F 17/30

(52) U.S. Cl. 707/610; 707/E17.005

(57) ABSTRACT

A method for providing a managing function of the storage service is disclosed. In accordance with the present invention, since a console database is synchronized with at least a portion of a catalog database, both a function that is provided by a storage manager and an additional function that is not provided by the storage manager may be provided to refer only the console database.

This application claims the benefit of Korean Patent Application No. 10-2009-0119023 filed on Dec. 3, 2009, which is hereby incorporated for reference.

### BACKGROUND OF THE INVENTION

1. Field of the Invention

The present invention relates to a method for providing a managing function of a storage service, and more particularly to a method for providing a managing function of a storage service wherein a managing function of a storage service may be provided to refer only a console database by synchronizing the console database with at least a portion of a catalog database.

2. Description of the Related Art

A storage system includes a client and a storage server wherein a backup of a data stored in the client is made in the storage server. The storage system makes the backup of the data in the storage server so that the data may be restored when the data is deleted or lost by a mistake of a user, an error of a software, a failure of a hardware, a computer virus, a theft, a cyber attack, a disaster and the like.

The storage system employs an application so-called a storage manager to carry out a backup task. Tivoli Storage Manager (TSM) by IBM and Netbackup by Symantec are some of well-known storage managers.

The storage manager is executed in the storage server. The storage manager provides storage services described below to the client connected to the storage server in order to backup the data and manage archives.

First, the storage manager guarantees a data integrity. The storage manager may protect the data stored in the storage server in order to prevent manipulation.

Second, the storage manager provides a data storage for the data. That is, the storage manager may store the data and programs of the client in storage of the storage server such as a tape cartridge, an optical disk, an opto-magnetic disk and hard disk arrays.

Third, the storage manager provides a security for the data. That is, the storage manager may restore the data and the programs from the storage server when the data is lost.

A conventional storage system employing the TSM by IBM is described hereinafter.

FIG. 1 is a block diagram illustrating the conventional storage system.

Referring to FIG. 1, the conventional storage system comprises a storage server 100, a client 200, a user console 300, a catalog database server 400 and a console database server 500. The storage server 100 may be a TSM server and the client 200 may be a TSM client.

The storage server 100 stores a data transmitted from the client 200. The storage server 100 stores the data based on a backup script received from the storage server 100.

The storage server 100 stores the data received from the client 200 in storage media such as a disk in a storage hierarchy and a tape volume.

The client 200 transmits the backup script to the storage server 100 and requests the storage server 100 to store the data. The client 200 may transmit the backup script to the storage server 100 directly. Alternately, the client 200 may transmit the backup script to the storage server 100 via a scheduler. The storage server 100 carries out a backup task based on the backup script.

The user console 300 is used by the user of the client 200 to create the backup script. The user console 300 may be a personal computer.

The catalog database server 400 stores a catalog database containing a data required for managing the storage service such as a schedule information, an event information and association information. The catalog database server 400 is connected to the storage server 100 to provide the catalog database to the storage server 100. In other words, the user of the client 200 may manage the storage service through the user console 300 based on the catalog database stored in the catalog database server 400.

In accordance with the conventional storage system, the user manages the storage service based on only the catalog database stored in the catalog database server 400. Therefore, the user may only utilize functions provided by the storage manager. For instance, if the storage manager does not provide a monitoring function, the user cannot monitor a certain backup task in the storage service

The console database server 500 may store a data required for managing the storage service, i.e., a console database relevant to additional functions that are not provided by the storage manager. The user may use the console database server 500 in order to utilize the additional functions that are not provided by the storage manager.

However, the user must refer to both the catalog database and the console database in order to utilize functions provided and not provided by the storage manager, which makes managing process very complex.

### SUMMARY OF THE INVENTION

It is an object of the present invention to provide a method for providing a managing function of a storage service wherein a managing function of a storage service may be provided to refer only a console database by synchronizing the console database with at least a portion of a catalog database.

In order to achieve above-described object of the present invention, there is provided a method for providing a managing function of a storage service, the method comprising steps of: (a) generating a console database including a second table generated by adding an extension to a first table included in a catalog database, wherein an information for managing the storage service is stored in the extension; (b) synchronizing at least a portion of the second table with the first table; and (c) providing a managing function of the storage service based on the second table synchronized in the step (b).

Preferably, the first table comprises a node information, a schedule information, an event information and association information.

Preferably, the step (b) is carried out periodically.

The method in accordance with the present invention may further comprise (d) receiving a user input for requesting the managing function of the storage service from a user console, prior to the step (c), and wherein the step (b) comprises synchronizing at least the portion of the second table with the first table, after carrying out the step (d).

Preferably, the information is transmitted from the user console to be recorded in the extension.

Preferably, the information is transmitted from the catalog database to be recorded in the extension

Preferably, the console database further comprises a third table storing an additional information received from at least one of a catalog database server storing the catalog database therein and a data storage server connected to the catalog database server.

Preferably, the additional information comprises at least one of a number of drives mounted, a number of sessions in use and a number of processes running in the data storage server.

Preferably, the third table stores a statistics figure for the additional information.

Preferably, the statistics figure comprises an average time necessary for carrying out the storage service, wherein the information comprises an estimated completion time obtained by adding the average time to a starting time of the storage service, and wherein the step (c) comprises providing an estimated remaining time obtained by subtracting a current time from the estimated completion time.

Preferably, the step (c) comprises transmitting a confirmation message to the user console when a predetermined time lapses from the estimated completion time.

### BRIEF DESCRIPTION OF THE DRAWINGS

FIG. 1 is a block diagram illustrating the conventional storage system.

FIG. 2 is a block diagram illustrating a storage system in accordance with the present invention.

FIG. 3 is a flow diagram illustrating a method for providing a managing function of a storage service in accordance with an embodiment of the present invention.

FIG. 4 is a flow diagram illustrating a method for providing a managing function of a storage service in accordance with another embodiment of the present invention.

### DETAILED DESCRIPTION OF THE INVENTION

A method for providing a managing function of a storage service in accordance with the present invention will be described in detail with reference to accompanied drawings.

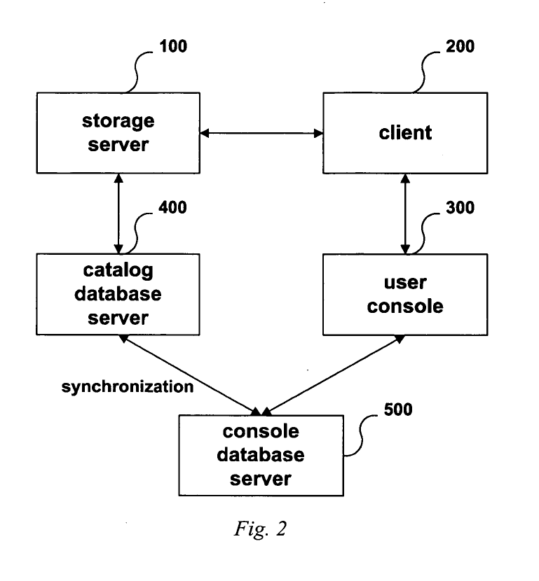

FIG. 2 is a block diagram illustrating a storage system in accordance with the present invention.

Referring to FIG. 2, the storage system in accordance with the present invention comprises a storage server 100, a client 200, a user console 300, a catalog database server 400 and a console database server 500.

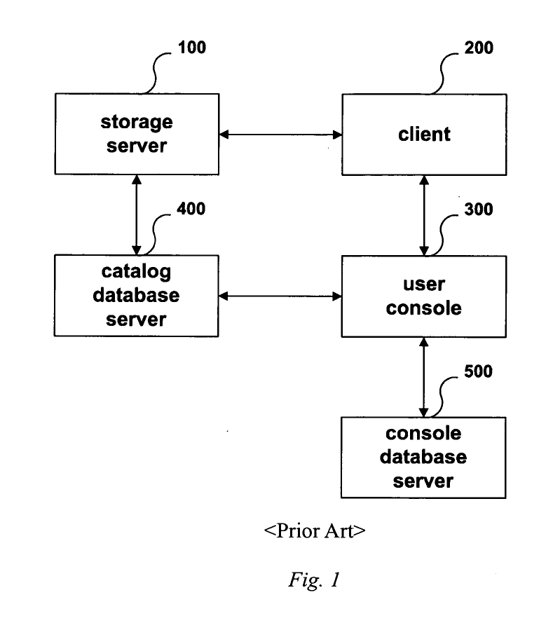

Since configurations of the storage server 100, the client 200, the user console 300, the catalog database server 400 and the console database server 500 in accordance with the present invention are identical to those described with reference FIG. 1, the detailed descriptions thereof are omitted.

There is a difference between the storage system in accordance with the present invention shown in FIG. 2 and the storage system in accordance with the conventional invention, wherein the console database server 500 is synchronized with at least a portion of the catalog database server 400.

Therefore, even if a user uses only the console database server 500, the user may be provided both a function provided by a storage manager and an additional function not provided by the storage manager.

A method for providing a managing function of the storage service in accordance with the present invention is detail described hereinafter.

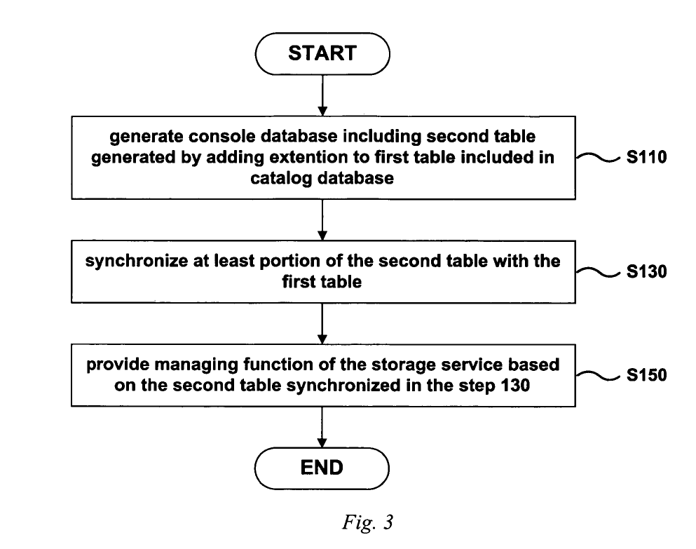

FIG. 3 is a flow diagram illustrating a method for providing a managing function of the storage service in accordance with an embodiment of the present invention.

Referring to FIG. 3, the console database server generates a console database including a second table generated by adding an extension to a first table included in a catalog database, wherein an information for managing the storage service is stored in the extension (S110).

The first table included in the console database stores a data relevant to the function that is provided by the storage manager, i.e., the data needed for providing the storage service. The data includes a node information, a schedule information, an event information and association information.

The event information includes an event, wherein it is happened in the storage service providing the schedule information. The association information includes a connection between the schedule information and the node information.

The console database stored in the console database server includes the second table generated by adding the extension storing the information for managing the storage service to the first table. A structure of the second table has a structure of the first table adding to the extension, the extension may be a column or a row.

Preferably, the information is a data relevant to the additional function that is not provided by the storage manager, i.e., the data is not provided by the catalog database server.

The information may be stored in the extension is described below.

First, the information, provided by the user console, is stored in the extension by recording.

The user inputs the information corresponding to the function to be added. The user console transmits the inputted information to the console database server. The console database server records the information received from the user console in the second table of the console database, i.e., the extension.

Second, the information, provided by the catalog database server, is stored in the extension by recording.

The catalog database server transmits the information for managing the storage service to the console database server. The console database server records the information received from the catalog database server in the second table of the console database, i.e., the extension.

Therefore, the user may be provided the managing function of the storage service to refer only the console database server without referencing the catalog database server.

Thereafter, the console database server synchronizes at least a portion of the second table with the first table (S130). For instance, when the storage system is changed, i.e., the first table included in the catalog database is changed, the second table included in the console database is updated to correspond to the first table.

Preferably, the portion of the second table is periodically synchronized with the first table. A synchronization interval of the second table may be a some minutes or hours interval.

Thereafter, the console database server provides the managing function of the storage service based on the second table synchronized in the step S130 (S150).

The second table is synchronized with the first table storing the data relevant to the functions that is provided by the storage manager, as well as stores the information, i.e., the data relevant to the additional functions that are not provided by the storage manager. Therefore, the user may be provided both the function that is provided by the storage manager and the additional function that is not provided by the storage manager to refer only the console database server.

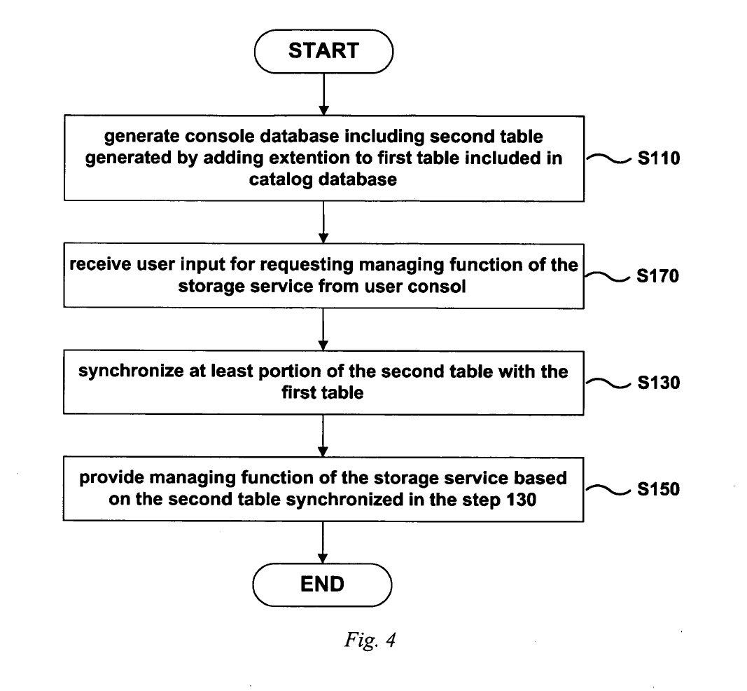

FIG. 4 is a flow diagram illustrating a method for providing a managing function of the storage service in accordance with another embodiment of the present invention.

Referring to FIG. 4, the method for providing the managing function of the storage service in accordance with the another embodiment of the present invention is added only a step S170 to the those described with reference to FIG. 3. Therefore, only changed issue by the step S170 in the method for providing the managing function of the storage service in accordance with the another embodiment of the present invention is in detail described hereinafter.

Referring to FIG. 4, the console database server generates a console database including a second table generated by adding an extension to a first table included in a catalog database, wherein an information for managing the storage service is stored in the storage service (S110).

The console database further comprises a third table storing an additional information received from at least one of the catalog database server and the storage server connected to the catalog database server.

Specifically, the additional information is not included in the first table and maintained on the catalog database server or the storage server.

Moreover, the third table may store a statistics figure for the additional information. The statistics figure may comprise an average time necessary for carrying out the storage service, for instance, the average time for the latest 10^{th} case of the storage service that is carried out successfully.

Thereafter, when the console database is generated via in the step S110, the console database server receives a user input for requesting the storage service from the user console. The user inputs a request message for the storage service provided via the user console. The user console generates and transmits the user input for the request message to the console database server.

Thereafter, the console database server synchronizes at least a portion of the second table with the first table (S130). The second table is synchronized with the first table after receiving the user input from the user console. Therefore, the second table may reflect the first table included in the catalog database, i.e., a present situation of the storage system.

Thereafter, the console database server provides the managing function of the storage service based on the second table synchronized in the step S130 (S150).

For instance, a case is assumed that the user wanted to know the required time provided the storage service.

When the user inputs a starting time of the storage service carried in the step S130 via a the user console, the console database server may store an estimated completion time, as the information, obtained by adding the average time of the storage service stored in the third table to the starting time of the storage service that is carrying out now. When the estimated completion time is stored in the console database as the information, the console database server may provide an estimated remaining time, to the user, obtained by subtracting a current time from the estimated completion time.

For another example, another case is assumed that the user wanted to know a normality or abnormality on the storage service relevant to the backup task lapsed away a predetermined time than the estimated completion time.

When the estimated completion time stored in the console database has elapsed more than an hour than the current time, the console database server generates and transmits a confirmation message passed the one hour to the user console. The user may confirm the normality or the abnormality on the storage service based on the confirmation message.

While the present invention has been particularly shown and described with reference to the preferred embodiment thereof, it will be understood by those skilled in the art that various changes in form and details may be effected therein without departing from the spirit and scope of the invention as defined by the appended claims.

What is claimed is:

1. A method for providing a managing function of a storage service, the method comprising steps of:
(a) generating a console database including a second table generated by adding an extension to a first table included in a catalog database, wherein an information for managing the storage service is stored in the extension;
(b) synchronizing at least a portion of the second table with the first table; and
(c) providing the managing function of the storage service based on the second table synchronized in the step (b).

2. The method in accordance with claim 1, wherein the first table comprises a node information, a schedule information, an event information and association information.

3. The method in accordance with claim 1, wherein the step (b) is carried out periodically.

4. The method in accordance with claim 1, further comprising (d) receiving a user input for requesting the managing function of the storage service from a user console, prior to the step (c), and
wherein the step (b) comprises synchronizing at least the portion of the second table with the first table, after carrying out the step (d).

5. The method in accordance with claim 1, wherein the information is transmitted from the user console to be recorded in the extension.

6. The method in accordance with claim 1, wherein the information is transmitted from the catalog database to be recorded in the extension

7. The method in accordance with claim 1, wherein the console database further comprises a third table storing an additional information received from at least one of a catalog database server storing the catalog database therein and a data storage server connected to the catalog database server.

8. The method in accordance with claim 7, wherein the additional information comprises at least one of a number of drives mounted, a number of sessions in use and a number of processes running in the data storage server.

9. The method in accordance with claim 7, wherein the third table stores a statistics figure for the additional information.

10. The method in accordance with claim 9, wherein the statistics figure comprises an average time necessary for carrying out the storage service,
wherein the information comprises an estimated completion time obtained by adding the average time to a starting time of the storage service, and
wherein the step (c) comprises providing an estimated remaining time obtained by subtracting a current time from the estimated completion time.

11. The method in accordance with claim 10, wherein the step (c) comprises transmitting a confirmation message to the user console when a predetermined time lapses from the estimated completion time.
